(19) United States
(12) Patent Application Publication
(10) Pub. No.: US 2006/0291577 A1
(43) Pub. Date: Dec. 28, 2006

(54) System and method for selecting pilot tone positions in communication systems

(76) Inventor: Adrian Boariu, Irving, TX (US)

Correspondence Address: SLATER & MATSIL, L.L.P., 17950 PRESTON RD, SUITE 1000, DALLAS, TX, 75252-5793, US

(21) Appl. No.: 11/441,873

(22) Filed: May 26, 2006

Related U.S. Application Data
(60) Provisional application No. 60/685,034, filed on May 26, 2005.

(51) Int. Cl. H04K 1/10

(52) U.S. Cl. 375/260

(57) ABSTRACT

A system and method for selecting pilot tone positions in a communication system. In one embodiment, the communication system includes a first base station configured to generate a first pattern of positions of pilot tones and a second base station configured to generate a second pattern of positions of pilot tones. The second pattern of positions of pilot tones is a nonuniform perturbation of an equispaced pattern of positions of pilot tones and is different from the first pattern of positions of pilot tones. The communication system also includes a mobile station configured to receive the first and second pattern of positions of pilot tones and identify one of the first and second base stations therefrom.

### CROSS REFERENCE TO RELATED APPLICATION

This application claims the benefit of U.S. Provisional Application No. 60/685,034, entitled “System And Method For Selecting Pilot Tone Positions In Communication Systems,” filed on May 26, 2005, which is incorporated herein by reference.

### TECHNICAL FIELD

The present invention is directed, in general, to communication systems and, in an exemplary embodiment, to a system and method for selecting pilot tone positions in orthogonal frequency division multiplexing (OFDM) communication systems.

### BACKGROUND

As wireless communication systems such as cellular telephone, satellite, and microwave communication systems become widely deployed and continue to attract a growing number of users, there is a pressing need to serve a large and variable number of communication subsystems transmitting a growing volume of data with a fixed resource such as a fixed channel bandwidth. Traditional communication system designs employing a fixed resource (e.g., a fixed frequency or a fixed time slot assigned to each user) have become challenged in view of the rapidly growing customer base.

Higher performance communication systems can operate by transmitting orthogonal signals over a channel. The orthogonal signals can be separated by a receiver using coherent (or matched) signal processing that relies on accurate knowledge of signal parameters such as channel gain, carrier frequency, carrier phase, and system timing. The aforementioned communication systems are often referred to as orthogonal frequency division multiplexing (OFDM) communication systems.

As an example of an OFDM communication system, a group of N bits of data from a signal source represented by the bit sequence {aᵢ}, i=0, . . . , N−1 including data in digital format is mapped into a sequence of “constellation” points {Xᵢ}, i=0, . . . , N in the complex plane with real and imaginary components (i.e., the N bits of data are mapped into 2·N real numbers represented by the N complex signal points). The constellations of signal points are formed using conventional techniques that space the signal points of an information signal in the complex plane with sufficient distances between the mapped points. The extra factor of two in the 2·N real numbers recognizes that complex numbers are formed with two real components. The N complex points can be thought of as points in a “frequency domain.”

The N complex points are then mapped into a sampled time function with real values {xᵢ}, i=0, . . . , (N−1) by performing an inverse fast Fourier transform (IFFT) on the complex signal sequence {Xᵢ}. The complex-valued, sampled time function {xᵢ} has frequency components corresponding to the frequency components of the IFFT process. After adding a cyclic prefix, the sampled time function {xᵢ} is converted into an ordinary, complex-valued, continuous time function x(t) by digital-to-analog conversion and filtering. The complex-valued signal x(t) is used to modulate a carrier waveform (both in-phase and quadrature phase) such as a 1.9 gigahertz (GHz) carrier for cellular telephony or for other applications such as digital audio or video broadcasting.

The wideband signal transmitted to a receiver such as a receiver for a mobile station is processed in numerous steps and is degraded by unknown and random processes including amplification, antenna coupling, signal reflection and refraction, corruption by the addition of noise, and further corruption by frequency and timing errors caused by a motion of the receiver and unpredictable variations in the transmission path. These processing steps, which produce channel “dispersion,” result in intersymbol interference (ISI) from signal frames transmitted about a signal frame of interest, and from signal frames transmitted by neighboring cellular base stations (communicating with the mobile station) that simultaneously occupy the same channel bandwidth. The signal frames are then corrupted by dispersion mechanisms, and accidentally acquire the characteristics of the signal of interest.

To protect against ISI, a guard interval corresponding to a number of leading or trailing signal components is often inserted between successive signal frames. The guard interval is usually formed in cellular telephony systems by inserting a “cyclic prefix” at the beginning of each signal frame. A cyclic prefix is typically chosen to be a set of the last signal components of the signal frame, which extends the length of the signal frame at the front end by the chosen length of the cyclic prefix. Upon reception of the extended signal frame, the cyclic prefix (representing redundant signal information) is discarded. The addition of a cyclic prefix makes a signal robust to multipath propagation. To allow a receiver of a mobile station, particularly in systems using orthogonal frequency division multiplexing, to reliably receive and detect the information in a signal frame (even with the insertion of a cyclic prefix), it is preferable to know the parameters of the channel such as the carrier frequency offset, channel gain and phase, and overall timing, all of which are generally unknown and varying at the receiver for reasons described above.

To compensate for unknown channel parameters, the transmitter inserts a set of pilot tones that are continually transmitted to the receivers in a fixed, known frequency-time pattern using a known data sequence and known amplitude. In essence, the pilot tones provide “training data” for the receiver. The pilot tones allow the receivers to estimate the channel impulse response and timing down to the chip level, which is preferable for reliable identification and reception of an unknown data sequence, and can even be used to identify and extract multipath signal components. The pilot tones may be transmitted with an unmodulated sequence to reduce the signal search dimensionality and to accommodate variable acquisition times in the initial receiver frequency acquisition process. The pilot tones can be shared by many users and can be transmitted with enhanced energy content. Since the pilot tones occupy valuable channel resources and consume transmitter energy, a limited set of such pilot tones is preferable.

The pilot tones are typically inserted by each transmitter in a frequency-time pattern that specifies the pilot tone sequence that will be used, such as a frequency-time pattern as illustrated in FIG. 1 (wherein an “X” represents a pilot tone). The pilot tones transmitted by one base station, however, can interfere with the pilot tones transmitted by another base station, typically by an adjacent base station. To reduce or avoid pilot tone interference, pilot tones for a contiguous group of base stations can be placed in random but fixed locations of a periodic frequency-time pattern commonly shared by all the base stations in the contiguous group. Other pilot tone placement strategies, such as patterns starting with Latin square sequences, have been used wherein the pilot tones of adjacent base stations are regularly shifted in a parallel slope arrangement and the pilot tones have different initial displacement position values. For an example of the use of pilot tones in a multicarrier spread spectrum system, see European Patent Application No. EP 1148674A2 entitled “Pilot use in Multicarrier Spread Spectrum Systems,” to Laroia, et al., priority date of Apr. 18, 2000, which is incorporated herein by reference.

An arrangement for an individual base station to preserve the quality of the reception process by inserting pilot tones at specified frequency locations across the channel is described by R. Negi and J. Cioffi (Negi, et al.), in “Pilot Tone Selection for Channel Estimation in a Mobile OFDM System,” IEEE Transactions on Consumer Electronics, vol. 44, no. 3, pp. 1122-1128, August 1998, and by S. Ohno and G. B. Giannakis (Ohno, et al.), in “Optimal Training and Redundant Precoding for Block Transmission with Application to Wireless OFDM,” IEEE Transactions on Communications, vol. 50, no. 12, pp. 2113-2123, December 2002, which are incorporated herein by reference. Based on the findings of the aforementioned references, pilot tones are equally spaced and are transmitted with equal power to provide enhanced channel parameter estimates by using, for instance, a mean square error criterion. For example, for a channel with 512 frequency components, 11 pilot tones may be inserted at frequency locations such as 0, 50, 100, 150, . . . , 500 to allow sufficiently accurate estimation of the channel characteristics by the receiver. Channel characteristics at intermediate frequency locations between the pilot tones are estimated in the receiver by interpolation.

For frequency division duplex (FDD) systems (i.e., systems that operate simultaneously on separate channels for both transmission and reception), L. Ping, in “A Combined OFDM-Cicada Approach to Cellular Mobile Communications,” IEEE Transactions on Communications, vol. 47, no. 7, pp. 979-982, July 1999, which is incorporated herein by reference, addresses deployment of cellular telephony systems with multiple adjacent cells by wrapping several OFDM symbols into a cyclic prefix code division multiple access (CDMA) superframe. This approach adds an additional guard interval (at the CDMA level) to the already available guard intervals embedded in the OFDM symbols, thereby reducing the spectral efficiency of the composite signal. It is not necessary to pre-encode the signal into OFDM symbols, as long as the cyclic prefix CDMA superframe is used. Thus, after the CDMA layer signal is detected at the receiver and its cyclic prefix is removed, it is not necessary to have additional guard intervals for the embedded OFDM symbols because the effect of multipath propagation has already been compensated for. Inasmuch as L. Ping employs the CDMA layer for insertion of a cyclic prefix, the reference fails to address the selection of pilot tones in the environment of wireless communication systems such as multicellular OFDM communication systems.

The estimation of carrier frequency offset is further addressed by M. Speth, S. Fetchel, G. Fock and H. Meyr (Speth, et al.) in “Digital Video Broadcasting (DVB): Framing, Structure and Modulation for Digital Terrestrial Television,” ETSI EN 300744, v1.4.1, August 2000, and in a case study entitled “Optimum Receiver Design for OFDM-Based Broadband Transmission—Part II: a Case Study,” IEEE Transactions on Communications, vol. 49, no. 4, pp. 571-578, April 2001, which are incorporated herein by reference. Speth, et al. provides a case study for a receiver for the DVB standard. Continuous pilot tones transmitted on fixed positions for the OFDM symbols are described to correct carrier frequency offsets that are a multiple integer of a tone. It should be understood that the DVB standard is a broadcast system, wherein base stations transmit or broadcast the same information simultaneously to multiple receivers. As a result, it is not necessary for receivers using the DVB standard to distinguish between different base stations.

Base stations generally broadcast continuously and employ the frequency division duplex system (i.e., wherein separate channels are used for downlink and uplink). A mobile station in such an environment faces the task of synchronizing with a desired base station in the presence of interference from adjacent base stations. Regarding next generation communication systems (e.g., 3.9G or 4G systems), interfrequency handover (handover from one frequency subband to a different frequency subband) may be an important consideration. Obtaining fast and accurate synchronization between a mobile station and a base station is advantageous. The base stations rely on the uniquely identifiable transmitted signals (e.g., the pilot tones) to allow a mobile station to synchronize to a targeted base station in the overage area.

In the synchronization process, the receiver of the mobile station does not know the channel parameters or the delays for the propagation paths nor the carrier frequency offsets. The synchronization process can be described as follows. A base station “k” typically has pilot tones on positions given by a fixed set {Setₖ} of pilot tone frequencies and the OFDM communication system typically uses discrete inverse and direct Fourier transforms of size N to produce transmitted signals. When a receiver performs the initial synchronization, the initial offset between the carrier frequency of the transmitting base station and the receiver of the mobile station is assumed to be no more than some limiting frequency difference dFₘₐₓ tones. Thus, the receiver of the mobile station typically searches in a range [−dFₘₐₓ, dFₘₐₓ] around the nominal base station transmitter frequency to lock onto the desired base station.

As a particular example of synchronization, assume that the pilot tones for base station “k,” as suggested by Negi, et al. and Ohno, et al., are equispaced (i.e., {Setₖ}={mₖ+J·m}, m=0, . . . , L−1, where “mₖ” is a positive integer offset specific to base station “k,” “L” is the range of channel multipaths that the OFDM communication system can accommodate, and “J” is an integer constant that provides the pilot tone separation for base station “k,” where N/L≧J). It is assumed that the pilot tones are equally powered. It is further assumed that the mobile station receives the signals from base station “k” (the targeted base station) as well as signals from another base station “j,” which may be an interfering base station. Thus, the mobile station attempts to synchronize to base station “k” and the initial carrier frequency offsets dFⱼ, dFₖ between the mobile station and base stations “j, k,” respectively. Also assume that n=dFⱼ−dFₖ+mⱼ−mₖ lies in the frequency search range [−dFₘₐₓ, dFₘₐₓ]. For this situation, we observe that n+dFₖ+{Setₖ}=dFⱼ+{Setⱼ}, which indicates that the mobile station can lock onto the interfering base station “j” as opposed to targeted base station “k.” Therefore, the mobile station performs additional operations to distinguish that it was locked onto the wrong base station. These operations require additional time, which is a limited resource, especially for an interfrequency handover that has tight switching time requirements.

As an example, consider a base station downlink channel arrangement with 512 frequency components (N=512), 11 pilot tones (L=11) and the separation between pilot tones being 50 (J=N/L). As illustrated in FIG. 2, assume that for base station “k” we have mₖ=0[i.e., {Setₖ}={0, 50, 100, . . . , 500}], while for base station “j”, mⱼ=5, [i.e., {Setⱼ}={5, 55, 105, 155, . . . , 505}]. Note that this is a particular example of the pilot tone position layout as proposed by Laroia, et al., to solve multicell deployment of an OFDM communication system in which the initial pilot tone displacements mₖ, mⱼ are different, the pilot tone separation is constant and the frequency-time period is one. Continuing the example, let the searching range for initial synchronization be [−dFₘₐₓ, dFₘₐₓ]=[−10, 10], and the carrier frequency offsets of the corresponding base stations relative to the receiver's (mobile) carrier frequency are dFₖ=1 and dFⱼ=−2. Note that in the initial synchronization stage, the carrier offsets dFⱼ, dFₖ are not known at the receiver. Due to the carrier offsets, the positions of the pilot tones as observed by the receiver are shifted as dFₖ+{Setₖ}={1, 51, 101, 151, . . . , 501} and dF_{j+{Set}ⱼ}={3, 53, 103, 153, . . . , 503}, which again are not known by the receiver. Note that the set dFⱼ+{Setⱼ} is the right circular shift of the set dFₖ+{Setₖ} by n=dFⱼ−dFₖ+mⱼ−mₖ=−2−1 +5−0=2, and both sets are in the search range [−10, 10] at the receiver.

Thus, when the receiver performs a search to synchronize to the targeted base station (e.g., base station “k”), it actually detects two base stations at initial offset values of one and three. However, because the pilot tone positions of a base station are a circular shift of the pilot tone positions of the other base station, the receiver has no additional information to determine if the initial offset value of one belongs to base station “k” or to base station “j.” The synchronization is more difficult if the signal from the desired base station “k” is weaker than the signal from the potentially interfering base station “j.” Thus, the receiver will likely synchronize, as Laroia, et al. observed, to the strongest signal base station, which may not be the targeted base station in an interfrequency handover process. The solution proposed by Laroia, et al., is also not suited for fast synchronization.

What is needed in the art, therefore, is a system and method of employing a pilot tone pattern design for a plurality of potentially interfering base stations that can reduce the possibility that a receiver of a mobile station can lock onto an interfering base station within its listening range, thereby decreasing the processing necessary to confirm a proper acquisition and synchronization, providing improved communication system performance while, at the same time, reducing communication start time for a mobile station.

### SUMMARY OF THE INVENTION

These and other problems are generally solved or circumvented, and technical advantages are generally achieved, by advantageous embodiments of the present invention, which includes a system and method for selecting pilot tone positions in a communication system. In one embodiment, the communication system includes a first base station configured to generate a first pattern of positions of pilot tones and a second base station configured to generate a second pattern of positions of pilot tones. The second pattern of positions of pilot tones is a nonuniform perturbation of an equispaced pattern of positions of pilot tones and is different from the first pattern of positions of pilot tones. The communication system also includes a mobile station configured to receive the first and second pattern of positions of pilot tones and identify one of the first and second base stations therefrom.

In another aspect, the present invention provides a transmitter communicating with a receiver in a communication system, and a related method of operating the same. In one embodiment, the transmitter includes an encoder configured to encode a stream of bits into encoded data and a pilot tone generator configured to generate a nonuniform perturbation of an equispaced pattern of positions of pilot tones and interleave the pattern of positions of pilot tones into the encoded data. The transmitter also includes an inverse fast Fourier transform module configured to convert the encoded data and the pattern of positions of pilot tones into a sampled, time-domain sequence thereof. The transmitter further includes a formatter configured to add a cyclic prefix to the sampled, time-domain sequence of encoded data and pattern of positions of pilot tones and a pulse shaping filter configured to shape the sampled, time-domain sequence of encoded data and pattern of positions of pilot tones. The transmitter still further includes a multiplier configured to modulate the sampled, time-domain sequence of encoded data and pattern of positions of pilot tones by a carrier frequency generated by a carrier frequency generator. The transmitter still further includes a band pass filter configured to filter the modulated, time-domain sequence of encoded data and pattern of positions of pilot tones and an antenna configured to send a transmitted signal including the modulated, time-domain sequence of encoded data and pattern of positions of pilot tones.

In another aspect, the present invention provides a receiver in a communication system, and a related method of operating the same. In one embodiment, the receiver includes an antenna configured to receive a received signal including a nonuniform perturbation of an equispaced pattern of positions of pilot tones. The receiver also includes a synchronizer configured to identify a base station based on the pattern of positions of pilot tones. The receiver further includes a deformatter configured to remove a cyclic prefix from the received signal and a fast Fourier transform module configured to convert the received signal into a frequency domain. The receiver still further includes a data selector configured to remove the pattern of positions of pilot tones from the received signal and a decoder configured to decode the received signal.

The foregoing has outlined rather broadly the features and technical advantages of embodiments of the present invention in order that the detailed description of the invention that follows may be better understood. Additional features and advantages thereof will hereinafter be described. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth herein.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a pattern of positions of pilot tones shared by a plurality of base stations;

FIG. 2 illustrates a block diagram of a pattern of positions of pilot tones for a plurality of base stations;

FIG. 3 illustrates a system level diagram of an embodiment of an OFDM communication system in accordance with the principles of present invention;

FIG. 4 illustrates a block diagram of an embodiment of a transmitter employable in a base station constructed according to the principles of the present invention;

FIG. 5 illustrates a block diagram of an embodiment of a receiver employable in a mobile station constructed according to the principles of the present invention; and

FIG. 6 illustrates a block diagram of a pattern of positions of pilot tones in accordance with the principles of present invention.

### DETAILED DESCRIPTION OF ILLUSTRATIVE EMBODIMENTS

The making and using of exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In one embodiment, an OFDM communication system employing at least a first base station and a second base station, and a mobile station is introduced herein. The first base station is configured to generate a first pattern of positions of pilot tones to be transmitted to a receiver of the mobile station. The first pattern of positions of pilot tones for the first base station is different from a second pattern of positions of pilot tones generated by the second base station, thereby creating a low cardinality of intersection between the first and second pattern of positions of pilot tones for an arbitrary circular shift thereof. The cardinality of the intersection of the first and second pattern of positions of pilot tones is preferably zero or a small number relative to the number of positions of pilot tones within a frequency range [−dFₘₐₓ, dFₘₐₓ] such as a synchronization range. The first pattern of positions of pilot tones may be a perturbation of a uniformly spaced pattern of positions of pilot tones. The first pattern of positions of pilot tones may also be used by the mobile station to identify the base station. Additionally, the first pattern of positions of pilot tones may be known by the receiver of the mobile station. The first pattern of positions of pilot tones may also be used by the receiver of the mobile station to receive training data.

In another aspect, the present invention provides a method of selecting a pattern of positions of pilot tones in an OFDM communication system. The method includes generating and transmitting a first pattern of positions of pilot tones from the base station to a receiver of a mobile station. The first pattern of positions of pilot tones is selected to be different from a second pattern of positions of pilot tones generated by a potentially interfering base station. As a result, a low cardinality of intersection between the first and second pattern of positions of pilot tones is created for a range of circular shifts (e.g., ten positions) thereof.

The principles of the present invention will be described with respect to exemplary embodiments in a specific context, namely, an OFDM communication system having a plurality of base stations employing different patterns of positions of pilot tones communicating over a channel to receivers of respective mobile stations. The mobile stations are communicating with a targeted base station to share training data for reliable data reception without substantial interference from another base station. It should be understood that the channel may be a dedicated channel for synchronization information and the like or it may be a portion of a channel that carries user information. The broad scope of the present invention is not limited to the classification of the channel.

The patterns of positions of pilot tones for the plurality of base stations are selected to provide a low cardinality of the intersection of the pattern of positions of pilot tones transmitted by one base station with the pattern of positions of pilot tones transmitted by another, possibly interfering base station (e.g., after some prescribed number of circular shifts in positions of pilot tones in a synchronization range). For instance, the patterns of positions of pilot tones may be a perturbation of equispaced tone positions across the channel to provide low cardinality of the intersection of the pattern of positions of pilot tones.

As a result of the system and method of exemplary embodiments of the present invention, pilot tone overlap between potentially interfering base stations in OFDM communication systems is reduced by employing different patterns of positions of pilot tones for different base stations and selecting patterns with the smallest or little cardinality of intersection relative to the number of positions of pilot tones. A characteristic associated therewith is that a receiver of a mobile station need not synchronize to the base station with the strongest signal, nor is the density of the pattern of positions of pilot tones modified for a channel estimation arrangement for a particular base station.

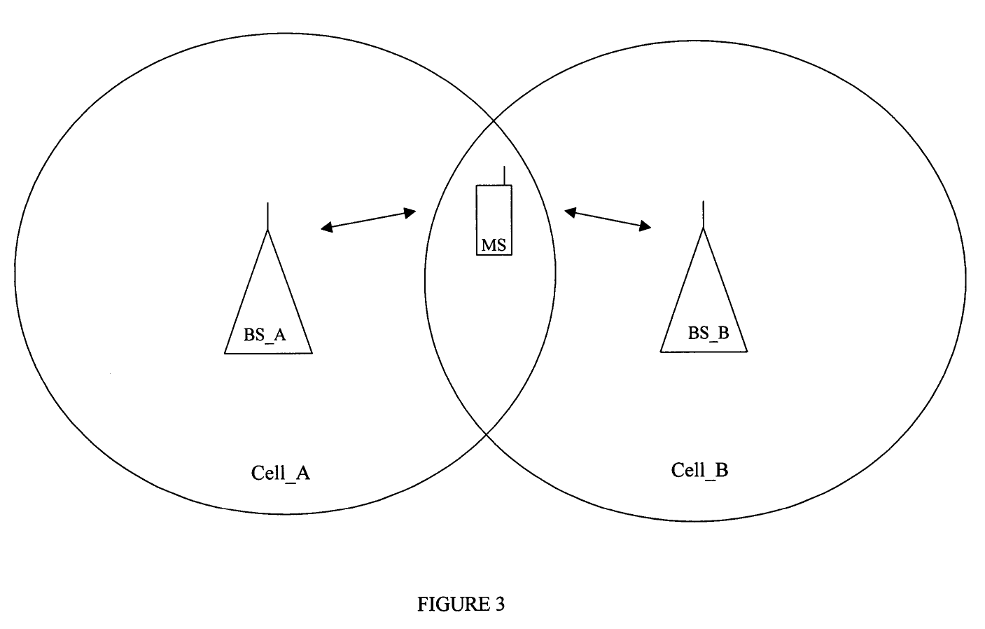

Referring now to FIG. 3, illustrated is a system level diagram of an embodiment of an OFDM communication system in accordance with the principles of the present invention. In the illustrated embodiment, the OFDM communication system is a cellular communication system that includes first and second base stations BS_{—A}, BS_B and a mobile station MS. As illustrated, each base station BS_{—A}, BS_B covers a cell designated as Cell_A for the first base station BS_A and Cell_B for the second base station BS_B. In the multicell environment of the cellular communications system, the mobile station MS may receive multiple signals over a channel from neighboring cells.

In the environment of a cellular communication system with a multicell OFDM communication system, “frequency reuse” refers to the allocation of different frequency subbands in adjacent cells to substantially avoid intercellular interference. For example, a cell surrounded by six adjacent cells may employ the allocation of seven frequency subbands to avoid mutual interference. Frequency reuse “one” means that adjacent base stations operate in the same frequency subband, and do not employ different frequency subbands for non-interfering operation. Assuming that frequency division duplex is used for transmission and reception (i.e., wherein the downlinks and uplinks employ different frequency subbands), the base stations typically continuously transmit in a particular, allocated common subband. A transmitter of the base station accommodates a system and method for positioning the frequencies of the positions of pilot tones to, for instance, facilitate the carrier offset estimation for an initial signal acquisition process between a base station and a mobile station. As a result, the mobile stations can more readily synchronize with the targeted base station without a degradation in communication performance due to interference from another base station.

In summary, the communication system includes a first base station configured to generate a first pattern of positions of pilot tones and a second base station configured to generate a second pattern of positions of pilot tones. The second pattern of positions of pilot tones is a nonuniform perturbation of an equispaced pattern of positions of pilot tones and is different from the first pattern of positions of pilot tones. The communication system also includes a mobile station configured to receive the first and second pattern of positions of pilot tones and identify one of the first and second base stations therefrom.

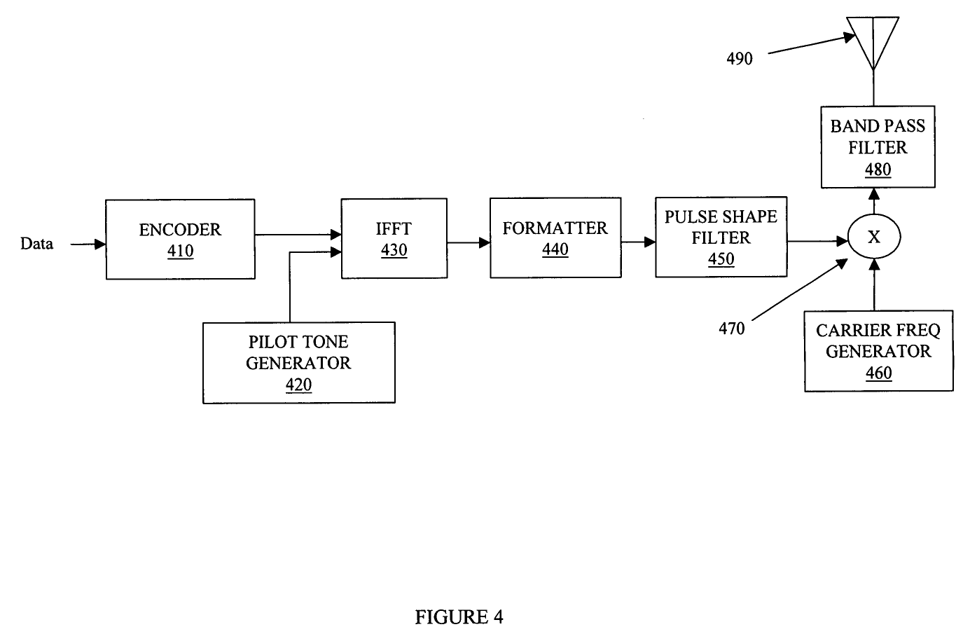

Turning now to FIG. 4, illustrated is a block diagram of an embodiment of a transmitter employable in a base station constructed according to the principles of the present invention. A stream of bits from a data source is encoded (e.g., mapped into points of a constellation in a complex plane) via an encoder 410 of the base station. The encoder 410 may include serial-to-parallel conversion of the data. A pilot tone generator 420 generates and interleaves pilot tones into a pattern of positions of pilot tones that is, for instance, a nonuniform perturbation of equispaced tones for use by a receiver such as a mobile station in an OFDM communication system. The encoded data and the pilot tones are thereafter converted into a sampled, time-domain sequence via an IFFT module 430. A cyclic prefix is added via a formatter 440 to assist in substantially avoiding intersymbol interference, followed by a pulse shape filter 450.

The resulting waveform modulates a carrier frequency waveform produced by carrier frequency generator 460 via a multiplier 470 and the resulting product waveform is filtered by a band pass filter 480. The filtered signal may be amplified by an amplifier (not shown) and is coupled to an antenna 490 to produce a transmitted signal. It should be understood that while the pilot tone generator 420 is shown located upstream of the IFFT module 430, the pilot tone generator 420 may be located at other positions in the transmitter to accommodate a particular application. While the transmitter includes a single path to encode, modulate and transmit the signal, it should be understood that multiple paths may be employed to accommodate multiple mobile stations. Additionally, while a single antenna (transmit antenna) has been illustrated and described, it should be understood that multiple transmit antennas may be employed, each preferably having a pilot tone generator associated therewith.

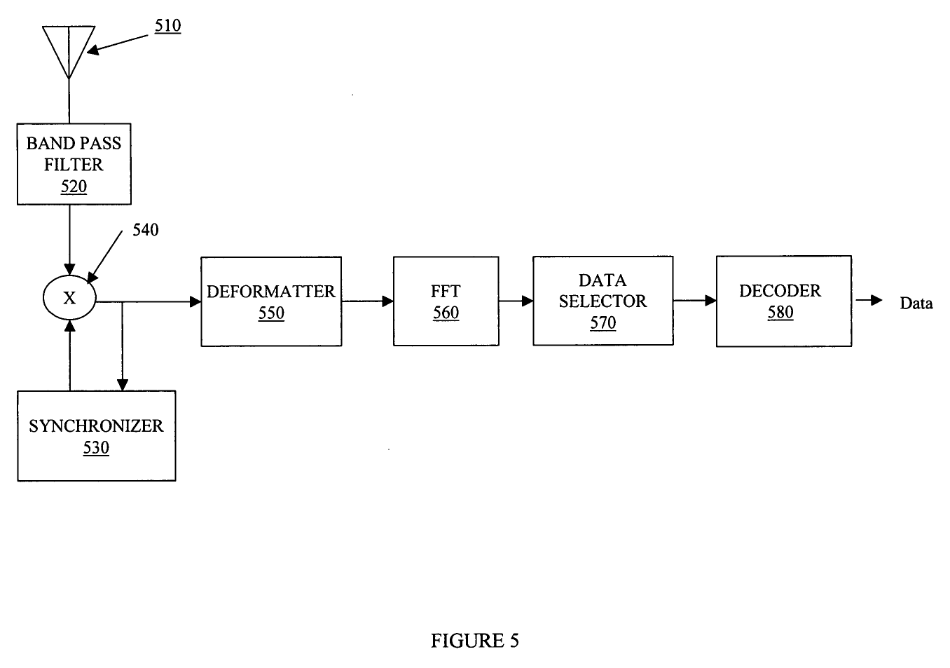

Turning now to FIG. 5, illustrated is a block diagram of an embodiment of a receiver employable in a mobile station constructed according to the principles of embodiments of the invention. At the receiver, a transmitted signal is received (also now referred to as a received signal) via an antenna 510 and is filtered by a band pass filter 520. A detection process includes carrier frequency generation, timing and synchronization via a synchronizer 530, which produces a local carrier signal synchronized with the carrier signal generated at the transmitter. As will become more apparent, the synchronizer 530 can identify a transmitter from, for instance, a base station based on a pattern of positions of pilot tones within the received signal. The synchronizer 530 may include a phase-locked loop or other technique for signal timing and synchronization as is well understood in the art. The local carrier signal and the band-pass filtered received signal are multiplied by a multiplier 540. The cyclic prefix is removed in a deformatting process via a deformatter 550 from the detected signal. The result is a sampled, time-domain sequence corresponding to the time-domain sequence as described with respect to FIG. 4.

A fast Fourier transform (FFT) is thereafter performed on the time-domain sequence via an FFT module 560, producing a sequence of points in the complex plane corresponding to the original transmitted data. The received signal is, therefore, converted into a frequency domain. The pilot tones are then removed from this sequence by a data selector 570 and the remaining points are remapped into the original transmitted data sequence (e.g., remap complex points into binary data) by a decoder 580, which may include parallel-to-serial data conversion as well. The data is thereafter provided for the benefit of a user.

Analogous to the transmitter illustrated and described with respect to FIG. 4, the receiver is provided for illustrative purposes and may be implemented in general purpose computers or in special purpose integrated circuits. Additionally, the subsystems of the transmitter and receiver of FIGS. 4 and 5 have been described at a high level, and for a better understanding of OFDM communication systems and the related subsystems see “Digital Communications,” by John G. Proakis, published by McGraw-Hill Companies, 4th Edition (2001), which is incorporated herein by reference.

As mentioned above, to allow a receiver such as a receiver for a mobile station using orthogonal frequency division multiplexing, to reliably receive and detect the information in a signal frame (even with the insertion of a cyclic prefix), it is preferable to know the parameters of the channel such as the carrier frequency offset, channel gain and phase, and overall timing, all of which are generally unknown and varying at the receiver for reasons described above. To compensate for unknown channel parameters, the transmitter of the base station inserts a set of pilot tones that are transmitted to the receivers of the mobile stations. In essence, the pilot tones provide “training data” for the receiver.

From the previous description and in some applications, it may not be advantageous to have the positions of the pilot tones of a base station configured as a circular shift of the positions of the pilot tones of another, possibly interfering base station (as proposed by Laroia, et al.). The system employable with a base station in accordance with an embodiment of the present invention provides that the pattern of positions of pilot tones of a particular base station near a group of possibly interfering base stations be unique, and that the cardinality of an intersection set {n+Setₓmod N}∩{Set_{y}} for any nε[−dFₘₐₓ, dFₘₐₓ] between potentially interfering base stations be relatively small, and possibly even zero. In order to be as close as possible to the equally spaced pilot tone frequencies for good channel estimation as suggested by Negi, et al. and Ohno, et al., a compromise in accordance with an embodiment of the present invention fixes the positions of the pilot tones as:
{Setₖ}={mₖ+dither_{k,m}+J·m}, for m=0, . . . , L−1,
wherein dither_{k,m} is a small, preferably deterministic perturbation of the pilot tone index “m” for base station “k.” Inasmuch as the small perturbation is arranged to be base-station dependent, it may also be employed as an indicator to identify a particular base station.

Thus, the actual values of the positions of the pilot tones may be different from one base station to another, potentially interfering base station. The perturbations in the positions of the pilot tones make a small compromise in the uniformity of the spacing thereof, which makes a small but generally unimportant degradation in the ability of a receiver to estimate channel parameters. However, a further advantage associated herewith is a lack of need for a receiver to lock onto the strongest signal, making the process substantially signal-strength independent. The aforementioned operation can be advantageous, without limitation, for handovers to another frequency subband from the same base station, particularly when a potentially interfering base station such as a neighboring base station is producing a stronger signal in the same frequency subband at the receiver location.

The perturbations of the positions of the pilot tone index can be determined by searching sets of dithers generated randomly, and then assessing the resulting pilot tone set intersections from the resulting set of dithers and picking or selecting the set with the smallest intersection. An alternative search process generates an ordered sequence of possible dithers, and again assesses the resulting pilot tone set intersections. Only a small number of sets of dithers are necessary in practice for adjacent or otherwise interfering base stations (typically fewer than 20 sets of dithers with a single transmit antenna). Thus, the perturbations are generated by searching and assessing sets of dithers generated randomly and selecting a set of dithers that create a pattern of positions of pilot tones with a small intersection with another pattern of positions of pilot tones.

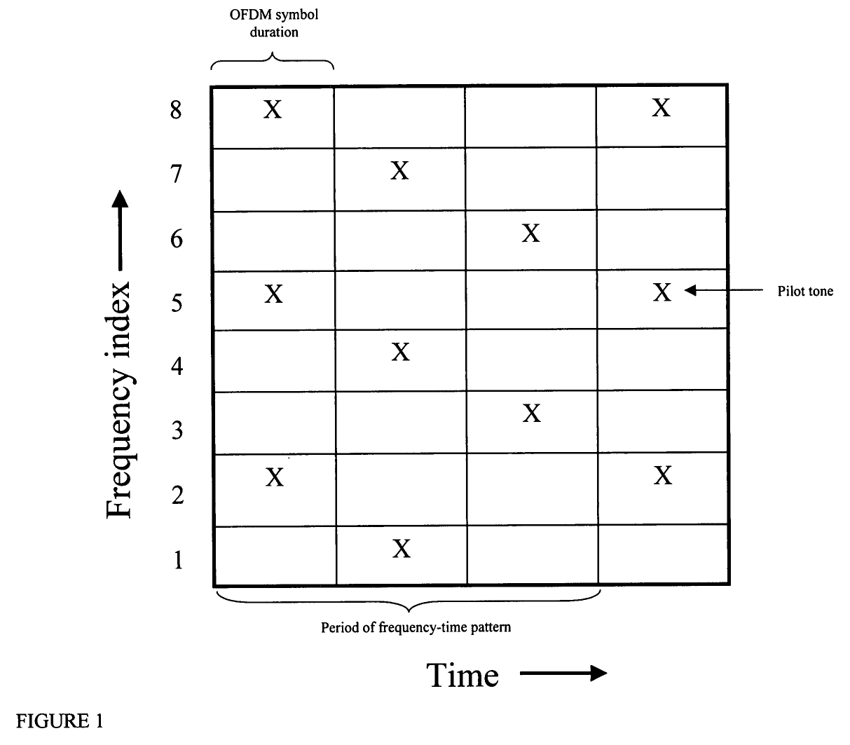

In order to provide a better understanding, we extend the example presented above with respect to Negi, et al. and Ohno, et al. to illustrate exemplary benefits associated with an embodiment of the present invention. First, the perturbation range is fixed, for example, to be between [−2, 2], which is small relative to the pilot tone separation J=50, in order to minimize the impact on the channel estimates. For simplicity, the dither sets are randomly generated. Thus, let {ditherₖ}={0, 1, 1, 2, 1, −2, 0, 2, 2, 0, 2} and {ditherⱼ}={0, −2, −1, 2, −2, −2, −1, −2, 1, −1, −2}. The positions of the pilot tones are {Setₖ}={ditherₖ}+{0, 50, 100, 150, . . . , 500}={0, 51, 101, 152, 201, 248, 300, 352, 402, 450, 502} and correspondingly {Setⱼ}={ditherⱼ}+{5, 55, 105, 155, . . . , 505}={5, 53, 104, 157, 203, 253, 304, 353, 406, 454, 503}, wherein the summation operation “+” is performed elementwise. There is no circular shift value “n” such that the set n+{Setₖ}, modulo N, fully overlaps the {Setⱼ}. Thus, a receiver is capable of synchronizing directly with the targeted base station signal by estimating the correct carrier offset of the targeted base station and not an interferer, based on the “signature” of the positions of the pilot tones in the frequency domain. This contrasts with the solution provided by Laroia et al., which usually locks onto the strongest signal. Note that the example presented here shows the patterns of positions of the pilot tones in the frequency domain for the sake of a simple explanation. The concept given by the equation above, however, can be extended to any patterns that are distributed in both the frequency and time domains, as illustrated in FIG. 1.

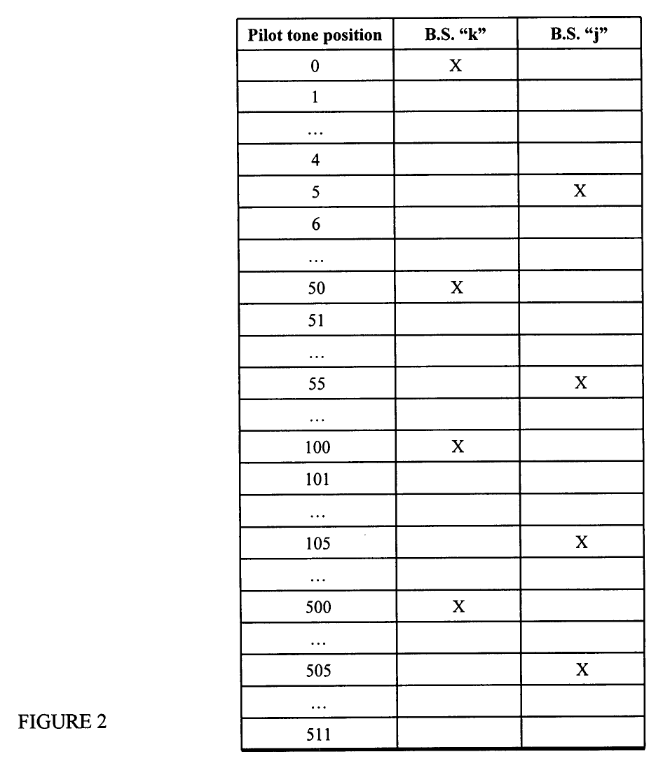

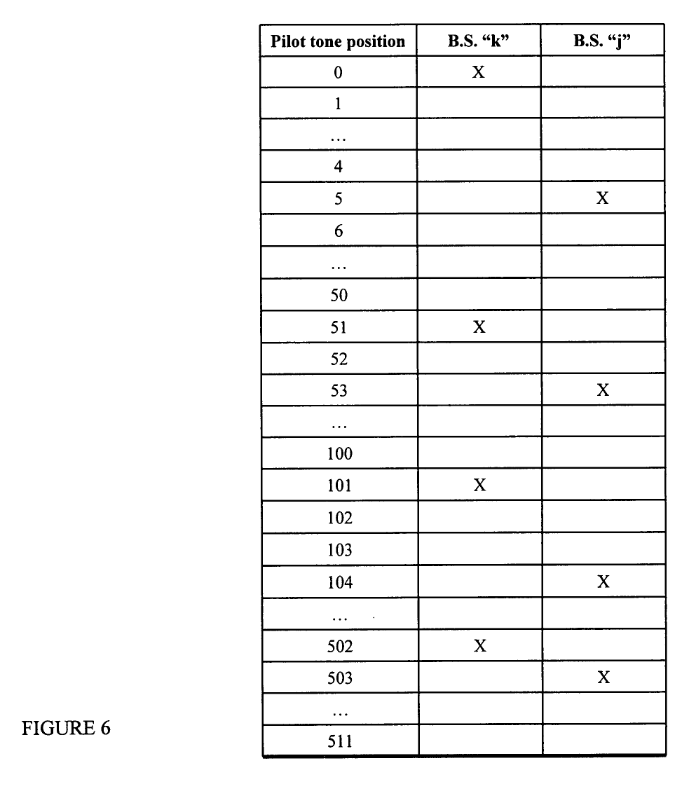

To better understand selected advantages associated with the principles of the present invention, a block diagram illustrating a pattern of positions of pilot tones according to the prior art of FIG. 2 will be contrasted with a block diagram of a pattern of positions of pilot tones according to the principles of the present invention of FIG. 6. Referring again to FIG. 2, illustrated is a pattern of positions of pilot tones for two base stations for a 512 tone channel. The Xs in the grid indicate the positions of the pilot tones. The positions of the pilot tones for base station “j” are placed in a circularly shifted pattern from the positions of the pilot tones for base station “k.” Unknown carrier frequency drift causes pilot tones to occupy higher or lower tone positions in the grid from the perspective of a receiver and aliasing of frequencies in the receiver causes the tones that fall off the top or bottom of the grid to be circularly reinserted at the bottom or top thereof, respectively (i.e., the positions of the pilot tones are numbered modulo 512 in the example). If the position of the pilot tones for base station “j” is circularly shifted up by five positions, then the cardinality of the intersecting set of pilot tones between the base stations in the illustrated example is 11. The result is indistinguishable patterns of positions of pilot tones when the transmitter offset frequency is unknown by the receiver in view of possible frequency drift and receiver motion.

Referring now to FIG. 6, illustrated is a block diagram of an embodiment of a pattern of pilot tones constructed according to the principles of the present invention. The selection of position of the pilot tones provided in the illustrated embodiment is for two base stations, again with a pilot tone assignment for a 512 tone channel. The Xs indicate the positions of the pilot tones, and are now perturbed from a pattern of regularly spaced tones. As before, unknown carrier frequency drift causes pilot tones to occupy higher or lower tone positions in the grid from the perspective of a receiver, and aliasing of frequencies in the receiver causes tones that fall off the top or bottom of the grid to be circularly reinserted at the bottom or top thereof, respectively (i.e., the pilot tone locations are numbered modulo 512).

In the pattern of positions of pilot tones provided herein, however, if the pilot tones of a particular base station in the present example are circularly shifted either up or down, the intersection of the set or pattern of positions of pilot tones of the particular base station with the set or pattern of positions of pilot tones of another, possibly interfering base station is, by inspection of the entries in the grid, much less than 11 pilot tones. Thus, the cardinality of the intersecting set or pattern of positions of pilot tones between the pair of base stations in the illustrated exemplary embodiment is, therefore, much less than 11. Either base station can thus be uniquely identified by its pattern of positions of pilot tones without accurate knowledge of its particular carrier frequency.

Thus, the principles of the present invention are operable in a communication system such as an OFDM communication system including a plurality of base stations that transmit communication signals on a channel to a plurality of receivers tuned thereto. Each base station transmits a pattern of positions of pilot tones to permit each receiver to receive training data such as synchronization information and the like over the channel. Additionally, at least one of the base stations employs a different pattern of positions of pilot tones from a pattern of position of pilot tones transmitted by another, potentially interfering base station, thereby providing a low cardinality of the intersection therebetween.

Although embodiments of the invention and its advantages have been described in detail, it should be understood that various changes, substitutions and alterations can be made herein without departing from the spirit and scope of the invention as defined herein. For example, it will be readily understood by those skilled in the art that methods and utilization of techniques to form the processes and systems providing reduced pilot tone interference between base stations as described herein may be varied (such as applying the principles of the present invention in applications employing a transmitter with multiple transmit antennas) while remaining within the broad scope of embodiments of the invention.

Moreover, the scope of the application is not intended to be limited to the particular embodiments of the process, machine, manufacture, composition of matter, means, methods and steps described in the specification. As one of ordinary skill in the art will readily appreciate from the disclosure of embodiments of the invention, processes, machines, manufacture, compositions of matter, means, methods, or steps, presently existing or later to be developed, that perform substantially the same function or achieve substantially the same result as the corresponding embodiments described herein may be utilized according to embodiments of the present invention. Accordingly, the aforementioned description is intended to include within the scope such processes, machines, manufacture, compositions of matter, means, methods, or steps.

What is claimed is:

1. A communication system, comprising:
a first base station configured to generate a first pattern of positions of pilot tones;
a second base station configured to generate a second pattern of positions of pilot tones being a nonuniform perturbation of an equispaced pattern of positions of pilot tones and different from said first pattern of positions of pilot tones; and
a mobile station configured to receive said first and second pattern of positions of pilot tones and identify one of said first and second base stations therefrom.

2. The communication system as recited in claim 1 wherein said first and second pattern of pilot tone positions provide a low cardinality of intersection therebetween.

3. The communication system as recited in claim 1 wherein said first and second pattern of pilot tone positions provide a low cardinality of intersection therebetween for an arbitrary circular shift thereof.

4. The communication system as recited in claim 1 wherein at least one of said first and second pattern of pilot tone positions employ a deterministic pattern.

5. The communication system as recited in claim 1 wherein said first and second pattern of pilot tone positions are distributed over time and frequency.

6. The communication system as recited in claim 1 wherein a cardinality of intersection of said first and second pattern of positions of pilot tones is a small number relative to a number of positions of pilot tones within a frequency synchronization range.

7. The communication system as recited in claim 1 wherein said mobile station employs at least one of said first and second pattern of pilot tone positions for training data.

8. The communication system as recited in claim 1 wherein said mobile station has knowledge of at least one of said first and second pattern of pilot tone positions.

9. The communication system as recited in claim 1 wherein said first and second pattern of pilot tone positions are selected to facilitate a carrier offset estimation for an initial signal acquisition process between said mobile station and said first and second base stations, respectively.

10. The communication system as recited in claim 1 wherein said communication system is an orthogonal frequency division multiplexing communication system.

11. A method of operating a communication system, comprising:
generating a first pattern of positions of pilot tones from a first base station;
generating a second pattern of positions of pilot tones from a second base station, said second pattern of positions of pilot tones being a nonuniform perturbation of an equispaced pattern of positions of pilot tones and different from said first pattern of positions of pilot tones; and
identifying one of said first and second base stations therefrom with a mobile station.

12. The method as recited in claim 11 wherein said perturbation is generated by searching and assessing sets of dithers generated randomly and selecting a set of dithers that create said second pattern of positions of pilot tones with a small intersection with said first pattern of positions of pilot tones.

13. The method as recited in claim 11 wherein said first and second pattern of pilot tone positions provide a low cardinality of intersection therebetween for an arbitrary circular shift thereof.

14. The method as recited in claim 11 wherein at least one of said first and second pattern of pilot tone positions employ a deterministic pattern.

15. The method as recited in claim 11 wherein said first and second pattern of pilot tone positions are distributed over time and frequency.

16. The method as recited in claim 11 wherein a cardinality of intersection of said first and second pattern of positions of pilot tones is a small number relative to a number of positions of pilot tones within a frequency synchronization range.

17. The method as recited in claim 11 wherein said mobile station employs at least one of said first and second pattern of pilot tone positions for training data.

18. The method as recited in claim 11 wherein said mobile station has knowledge of at least one of said first and second pattern of pilot tone positions.

19. The method as recited in claim 11 wherein said first and second pattern of pilot tone positions are selected to facilitate a carrier offset estimation for an initial signal acquisition process between said mobile station and said first and second base stations, respectively.

20. The method as recited in claim 11 wherein said communication system is an orthogonal frequency division multiplexing communication system.

21. A transmitter in a communication system, comprising:
an encoder configured to encode a stream of bits into encoded data; and
a pilot tone generator configured to generate a nonuniform perturbation of an equispaced pattern of positions of pilot tones and interleave said pattern of positions of pilot tones into said encoded data.

22. The transmitter as recited in claim 21 further comprising an inverse fast Fourier transform module configured to convert said encoded data and said pattern of positions of pilot tones into a sampled, time-domain sequence thereof.

23. The transmitter as recited in claim 21 further comprising a formatter configured to add a cyclic prefix to said encoded data and pattern of positions of pilot tones.

24. The transmitter as recited in claim 21 further comprising a multiplier configured to modulate said encoded data and pattern of positions of pilot tones by a carrier frequency generated by a carrier frequency generator.

25. The transmitter as recited in claim 21, further comprising:
a plurality of encoders configured to encode a stream of bits into encoded data; and
a plurality of pilot tone generators configured to generate a nonuniform perturbation of an equispaced pattern of positions of pilot tones and interleave said pattern of positions of pilot tones into said encoded data.

26. The transmitter as recited in claim 21 wherein said pattern of positions of pilot tones are configured to provide training data for a receiver communicating with said transmitter in said communication system.

27. The transmitter as recited in claim 21 wherein said pattern of positions of pilot tones is different from another pattern of positions of pilot tones generated by another transmitter.

28. The transmitter as recited in claim 21 wherein said perturbations are generated by searching and assessing sets of dithers generated randomly and selecting a set of dithers that create said pattern of positions of pilot tones with a small intersection with another pattern of positions of pilot tones.

29. The transmitter as recited in claim 21 wherein said transmitter is embodied in a base station in said communication system.

30. The transmitter as recited in claim 21 wherein said communication system is an orthogonal frequency division multiplexing communication system.

31. A method of operating a transmitter in a communication system, comprising:
encoding a stream of bits into encoded data; and
generating a nonuniform perturbation of an equispaced pattern of positions of pilot tones.

32. The method as recited in claim 31 further comprising converting said encoded data and said pattern of positions of pilot tones into a sampled, time-domain sequence thereof.

33. The method as recited in claim 31 further comprising adding a cyclic prefix to said encoded data and pattern of positions of pilot tones.

34. The method as recited in claim 31 further comprising modulating said encoded data and pattern of positions of pilot tones by a carrier frequency.

35. The method as recited in claim 31 further comprising interleaving said pattern of positions of pilot tones into said encoded data.

36. The method as recited in claim 31 wherein said pattern of positions of pilot tones are configured to provide training data for a receiver communicating with said transmitter in said communication system.

37. The method as recited in claim 31 wherein said pattern of positions of pilot tones is different from another pattern of positions of pilot tones generated by another transmitter.

38. The method as recited in claim 31 wherein said perturbations are generated by searching and assessing sets of dithers generated randomly and selecting a set of dithers that create said pattern of positions of pilot tones with a small intersection with another pattern of positions of pilot tones.

39. The method as recited in claim 31 wherein said transmitter is embodied in a base station in said communication system.

40. The method as recited in claim 31 wherein said communication system is an orthogonal frequency division multiplexing communication system.

41. A receiver in a communication system, comprising:
an antenna configured to receive a received signal including a nonuniform perturbation of an equispaced pattern of positions of pilot tones; and
a synchronizer configured to identify a base station based on said pattern of positions of pilot tones.

42. The receiver as recited in claim 41 further comprising a band pass filter configured to filter said received signal.

43. The receiver as recited in claim 41 further comprising a deformatter configured to remove a cyclic prefix from said received signal.

44. The receiver as recited in claim 41 further comprising a fast Fourier transform module configured to convert said received signal into a frequency domain.

45. The receiver as recited in claim 41 further comprising a data selector configured to remove said pattern of positions of pilot tones from said received signal.

46. The receiver as recited in claim 41 further comprising a decoder configured to decode said received signal.

47. The receiver as recited in claim 41 wherein said pattern of positions of pilot tones are configured to provide training data for said receiver.

48. The receiver as recited in claim 41 wherein said receiver has knowledge of said pattern of positions of pilot tones.

49. The receiver as recited in claim 41 wherein said perturbations are generated by searching and assessing sets of dithers generated randomly and selecting a set of dithers that create said pattern of positions of pilot tones with a small intersection with another pattern of positions of pilot tones.

50. The receiver as recited in claim 41 wherein said receiver is embodied in a mobile station in an orthogonal frequency division multiplexing communication system.

51. A method of operating a receiver in a communication system, comprising:
receiving a received signal including a nonuniform perturbation of an equispaced pattern of positions of pilot tones; and
identifying a base station based on said pattern of positions of pilot tones.

52. The method as recited in claim 51 further comprising filtering said received signal.

53. The method as recited in claim 51 further comprising removing a cyclic prefix from said received signal.

54. The method as recited in claim 51 further comprising converting said received signal from a time domain into a frequency domain.

55. The method as recited in claim 51 further comprising removing said pattern of positions of pilot tones from said received signal.

56. The method as recited in claim 51 further comprising decoding said received signal.

57. The method as recited in claim 51 wherein said pattern of positions of pilot tones are configured to provide training data for said receiver.

58. The method as recited in claim 51 wherein said receiver has knowledge of said pattern of positions of pilot tones.

59. The method as recited in claim 51 wherein said perturbations are generated by searching and assessing sets of dithers generated randomly and selecting a set of dithers that create said pattern of positions of pilot tones with a small intersection with another pattern of positions of pilot tones.

60. The method as recited in claim 51 wherein said receiver is embodied in a mobile station in an orthogonal frequency division multiplexing communication system.
